(19) United States
(12) Patent Application Publication
(10) Pub. No.: US 2009/0159459 A1
(43) Pub. Date: Jun. 25, 2009

(54) Electrochemical Recovery of Arsenic

(75) Inventors: Robert Lewis Clarke, Orinda, CA (US); Samaresh Mohanta, San Diego, CA (US); Stephen Harrison, Benicia, CA (US); Brian J. Dougherty, Menlo Park, CA (US)

Correspondence Address: FISH & ASSOCIATES, PC;ROBERT D. FISH, 2603 Main Street, Suite 1000, Irvine, CA, 92614-6232, US

(73) Assignee: EVERCLEAR SOLUTIONS, INC., Emeryville, CA (US)

(21) Appl. No.: 12/064,581

(22) PCT Filed: Aug. 10, 2006
(86) PCT No.: PCT/US06/31486

§ 371 Date: Sep. 25, 2008

Related U.S. Application Data
(60) Provisional application No. 60/711,274, filed on Aug. 24, 2005.

(51) Int. Cl. C02F 1/461

(52) U.S. Cl. 205/742; 204/232

(57) ABSTRACT

Contemplated devices and methods for arsenic recovery employ a two-step process in which an arsenite and arsenate-containing solution is first subjected to a non-electrochemical reduction that reduces arsenate and arsenite. The arsenate-depleted arsenite-containing solution is the subjected to electrochemical reduction at alkaline pH using a cathode with a high-surface carbon portion. Most preferably, the treated solution is then used as eluent for an adsorbent that removed arsenate and arsenite from a water supply.

This application claims priority to our copending U.S. provisional patent application with the Ser. No. 60/711,274, which was filed Aug. 24, 2005.

### FIELD OF THE INVENTION

Recovery of arsenic, particularly as it relates to environmental remediation.

### BACKGROUND OF THE INVENTION

Increasing levels of dissolved arsenic in groundwater has emerged as a major concern for drinking water supplies. Among other sources, soil leaching, combustion of fossil fuels, runoff from glass and electronic production wastes, and naturally occurring inorganic arsenic deposits (typically as arsenite As(III), or arsenate As(V)) significantly contribute to drinking water contamination and pose a substantial threat to human health. For example, exposure to arsenic has been associated with skin diseases, nausea, diarrhea, decreased production of blood vessels, and cancers and tumors of the bladder, kidney, liver, and lung. In light of these problems, the EPA recently lowered the maximum allowed arsenic concentration in drinking water from 50 ppb to 10 ppb.

Numerous configurations and methods are known for removing arsenic from drinking water and include precipitation with iron or copper, and/or immobilization of arsenic with biological agents. However, such methods often fail to achieve removal below the ppm level. Moreover, precipitation technologies often co-precipitate non-toxic ions as well and tend to deplete the soil or other source from otherwise desirable minerals and ions.

Alternatively, resins with more or less pronounced selectivity towards arsenic species can be employed to strip the water or aqueous solvent from the arsenic. For example, hybrid ion exchange resins exhibit excellent mechanical strength and attrition resistance and high selectivity towards both As(III) and As(V). Thus, the electrolytic quality of treated water is typically not significantly altered. Other ion exchange resins are impregnated with nanosized particles of iron, rendering such resin selective for As(III) and As(V). Still other known strong anion exchange resins can be used to adsorb arsenic species, wherein such resins may be used as provided, or may be modified with immobilized iron or copper. In such cases, the ion exchange resin may also be replaced with an iminodiacetic acid chelating resin that is then loaded with iron. While such resins advantageously reduce arsenic species to levels below 10 ppb, numerous difficulties remain. Among other things, ion selectivity is often less than desirable, and resins tend to deteriorate over time. Moreover, use of such resins only shifts the arsenic from the water to the eluent, which cannot be drained without significant damage to the environment.

To circumvent at least some of the problems associated with resins, non-resinous adsorbents can be employed. Particularly well-suited sorbents include zirconium hydroxide, titanium hydroxide, hafnium hydroxide, and combinations thereof as described in U.S. Pat. No. 6,383,395. Such compounds exhibit high selectivity to arsenic species and a high binding capacity, are commercially available at low price, and are generally not problematic with respect to toxicity or environmental impact. While such sorbents solve at least some of the above problems, eluents nevertheless require treatment.

Arsenic species may also be oxidized or reduced to thereby form species that will, upon suitable treatment, precipitate or otherwise form a solid matter that can then be removed from the solvent. For example, various oxidation processes are described in U.S. Pat. Nos. 5,368,703 and 5,858,249, wherein arsenite is oxidized to arsenate via ferrous oxidation or a sacrificial iron anode, and wherein the corresponding iron-arsenate then precipitates from the solution. Similarly, removal of arsenic from synthetic acid mine drainage was described by electrochemical pH adjustment and co-precipitation with iron hydroxide (Environ Sci Technol. 2003 Oct. 1;37(19):4500-6). Here, the pH of the arsenic-containing solution was raised by electrochemical reduction of H+ to elemental hydrogen and arsenic was coprecipitated with iron(III) hydroxide, following aeration of the catholyte. In other oxidation processes, arsenic species are oxidized at pressure and precipitated using iron as disclosed in U.S. Pat. No. 6,398,968. In yet another approach, microbial oxidation is used to precipitate arsenate as described in U.S. Pat. No. 6,461,577, while U.S. Pat. App. No. 2005/0167285 describes removal of arsenate by adsorption of metal hydroxide that is formed by ‘in-situ’ anodic oxidation.

In other approaches, various reduction processes were described. For example, arsenic species in marine waste materials (e.g., powderized scallops intestines) were subjected to reduction to deposit arsenic in an acid solution onto an electrode as taught in EP 1 008 304. The so deposited arsenic is then stripped from the electrode in an alkaline reverse process. However, electrochemical reduction of arsenate to arsenite in acidic medium is very slow and inefficient (less than 1% current efficiency). Thus, as arsenic is typically present in a mixture of arsenite and arsenate, most known electrochemical reductions fail to completely remove arsenic from a source material. Moreover, even if all arsenate would be converted to arsenite, electrochemical reduction of arsenite tends to also produce arsine, which is highly toxic and highly flammable. Under specific conditions, As-III or As-V compounds (but not mixtures thereof) can be electrochemically reduced to arsenic on platinum or copper cathodes. Others have reported the use of gold cathodes and suspended or gold compounds to reduce arsenates (see P. Grundler and G. U. Flechig, Deposition and stripping at heated microelectrodes, As(V) at a gold electrode. Electrochimica Acta, vol 43, pp 3451-3458). However, such electrodes are highly expensive and are therefore commercially not attractive (note that reduction of As(V) is especially difficult and uneconomic). To complicate matters, it is also known that depending on the particular electrochemical conditions arsine may be produced, which is even less desirable.

In further known approaches, arsenic can also be chemically reduced as described in U.S. Pat. No. 6,495,024, where arsenic is removed from concentrated sulfuric acid solution (sulfuric add concentration is at least 300 g/l) at a temperature of 50-105° C. by reducing the arsenic in the solution with sulfur dioxide. The so formed arsenic trioxide (As₂O₃) is then crystallized from the sulfuric acid solution by cooling. In another approach, as described in Anal Bioanal Chem. 1996 March;354(7-8):866-9, or Anal Bioanal Chem. 1996 June;355(3-4):324-6, As(V) is reduced to As(III) on-line by potassium iodide or L-cysteine at 95° C. in a method of determination of total inorganic arsenic. While such methods reduce arsenate to arsenite in satisfying yields, workup of the solutions is generally problematic and/or not economically attractive. Moreover, addition of such reducing agents results in yet another undesirable component in the solvent.

Therefore, while numerous methods for arsenic removal are known in the art, all or almost all of them suffer from one or more disadvantages. Consequently, there is still a need for improved methods for arsenic removal from various sources, especially from water and leachates.

### SUMMARY OF THE INVENTION

The present invention is directed to devices and methods of removal of arsenate and arsenite from aqueous solutions in which the arsenate is selectively reduced to arsenite using a non-electrochemical process, and in which the remaining arsenite is then electrochemically reduced to metallic arsenic on a cathode comprising a high-surface carbon portion at alkaline pH. Most preferably, the cathode comprises a carbon felt portion through which at least part, and most preferably all of the catholyte is pumped using a catholyte recirculation circuit.

In one aspect of the inventive subject matter, a method of removing arsenic from an aqueous solution includes a step of providing an aqueous solution containing arsenate and arsenite. In another step, a redox agent is added the aqueous solution at a concentration effective to reduce the arsenate in the solution to arsenite to thereby form a substantially arsenate depleted aqueous solution. In yet another step, the arsenate depleted aqueous solution is contacted with a cathode that comprises a high-surface carbon portion, and in a still further step, the arsenite is electrochemically reduced in the arsenate depleted aqueous solution at a current effective to deposit metallic arsenic on a cathode to thereby produce a solution that is depleted of arsenic species.

Preferably, the step of contacting the arsenate depleted aqueous solution comprises a step of pumping the arsenate depleted aqueous solution through the cathode compartment, wherein pumping is even more preferably performed while electrochemically reducing the arsenite. It is furthermore particularly preferred that the arsenate depleted aqueous solution is pumped through the high-surface carbon portion. Electrochemical reduction of the arsenite is typically performed at a current below a current effective to generate hydrogen at the cathode, and the pH is preferably maintained between 8 and 11.

In further preferred methods, a step of eluting an arsenate/arsenite loaded adsorbent with alkaline eluent is added to thereby provide the aqueous solution containing arsenate and arsenite, wherein the arsenate and arsenite from a water supply may be adsorbed onto an adsorbent (e.g., zirconium hydroxide, titanium hydroxide, and/or hafnium hydroxide) to thereby form the arsenate and arsenite loaded adsorbent. Where desirable, the solution that is depleted of arsenic species may then be used as an eluent for the arsenate and arsenite loaded adsorbent. Preferred redox agents include hydrazine, sulfur dioxide, metabisulfite, sulfide, powdered aluminum, and powdered zinc, and preferred high-surface carbon portions include carbon felt.

Consequently, in another aspect of the inventive subject matter, an apparatus includes a first reactor fluidly coupled to an adsorbent system, wherein the first reactor is configured to receive an arsenate and arsenite containing eluent from the system. In such devices, a mixing system is at least temporarily coupled to the first reactor and configured to admix a redox reagent with the arsenate and arsenite containing eluent, wherein the mixing system is further configured to mix the reagent with the eluent to a degree effective to allow for substantially complete reduction of arsenate in the eluent to arsenite. An electrolytic cell with an anode compartment and a cathode compartment is included, wherein the cathode compartment is fluidly coupled to the first reactor such that the eluent is circulated from the cathode compartment to the first reactor and from the first reactor to the cathode compartment while electrolysis is in progress, and wherein the cathode compartment includes a cathode comprising a high-surface carbon portion.

Most preferably, the electrolytic cell is configured to allow plating of arsenic onto the cathode from the arsenite to a degree effective to produce the eluent, and the first reactor is further configured to provide an eluent to the system. Among other options, preferred mixing devices include and impeller, a sparger, an optionally rotating agitator, and/or a blade. It is also generally preferred that the device includes a catholyte recirculation pump that is fluidly coupled to the cathode compartment and the first reactor, and that the cathode compartment is configured such that at least part of the catholyte flows through the high-surface carbon portion (e.g., carbon felt).

Various objects, features, aspects and advantages of the present invention will become more apparent from the following detailed description of preferred embodiments of the invention, along with the accompanying drawing.

### BRIEF DESCRIPTION OF THE DRAWINGS

FIG. 1 is a schematic illustration of a system according to the inventive subject

matter.

FIG. 2 is a graph depicting concentration of arsenic species in the sodium hydroxide eluent for concentrations of sodium hydroxide from 1 M to 4 M, at a flow rate of about 1 bed volume per minute (BV/min).

FIG. 3 is a graph depicting the amount of arsenic species desorbed from the medium relative to the initial amount of arsenic species loaded onto the medium.

### DETAILED DESCRIPTION

The inventors have surprisingly discovered that that arsenic species can be recovered from various sources, and particularly from aqueous solutions containing mixtures of arsenite and arsenate using a first step in which arsenate in the mixture is selectively converted to arsenite, and a second step in which total arsenite (i.e., originally present plus arsenite formed from arsenate) is electrochemically reduced to metallic arsenic using a high-surface area cathode.

As used herein, the term “arsenic species” refers to the cationic forms of arsenic, and especially to arsenite and arsenate (or As(III) and As(V), As-III and As-V, or As³⁺ and As5+, respectively). As also used herein, the term “anode” refers to the electrode in the electrolytic cell at which oxidation occurs when current is passed through the electrolytic cell. Therefore, under typical operating conditions, molecular oxygen (O₂) is generated at the cathode from water. As further used herein, the term “anolyte” refers to the electrolyte that contacts the anode. As yet further used herein, the term “cathode” refers to the electrode in the electrolytic cell at which reduction occurs when current is passed through the electrolytic cell. Therefore, under typical operating conditions, elemental metals are plated onto the cathode from ionic metals. Consequently, the term “catholyte” refers to the electrolyte that contacts the cathode. In most embodiments according to the inventive subject matter, the anolyte is separated from the catholyte via a separator that allows migration of a charged species from the anolyte to the catholyte (and vice versa), but is otherwise impermeable for the anolyte and catholyte.

It is generally contemplated that arsenic species can be obtained from numerous sources, and that the particular source will typically not affect the inventive concept presented herein. For example, and especially where the concentration of arsenic species in an aqueous solution is relatively high (e.g., mine drainage), the solution can be directly treated as described further below. On the other hand, where the concentration of arsenic species in an aqueous solution is moderate or relatively low (e.g., water from a chip manufacture plant or aquifer), the solution may also be passed through one or more adsorbent devices. There are many adsorbents and methods of enriching arsenic species known in the art, and all of the known methods and devices are deemed suitable for use herein. For example, appropriate devices and methods include ion exchange chromatography (typically using strong anionic exchange resins), precipitation, and chelation. However, in an especially preferred aspect, arsenic species are enriched and/or isolated from water using zirconium hydroxide, titanium hydroxide, and/or hafnium hydroxide as affinity medium. Especially preferred devices using such adsorbents are described in U.S. Pat. No. 6,383,395, which is incorporated by reference herein. Moreover, and depending on the particular source of the arsenic species, it should be appreciated that the aqueous solution may selectively include only As(III) or As(V), or any mixture thereof, which may further include additional metallic ions. Alternatively, the arsenic species may also be treated (see below) before capture on the adsorbent such that the aqueous solution includes predominantly, and more typically exclusively As(III), which may then be adsorbed.

As arsenite and arsenate usually exist together in ground water, arsenate must be first reduced to arsenite before arsenite can be deposited on a cathode as metallic arsenic. If such step (i.e., reduction of arsenate to arsenite) would be performed electrochemically as depicted in the equation below, the reduction would be extremely slow.

AsO₄³⁻+4H⁺+2e⁻⇄AsO₂⁻+2H₂O

Moreover, even when reduction would be accelerated in acidic media, comparative current efficiency on a high surface area carbon felt electrode is 0.4% for arsenate to arsenic compared to close to 100% for the reduction of arsenite to arsenic under the same conditions. Still further, electrochemical reduction of arsenate/arsenite mixtures in acid medium tend to produce undesirable quantities of arsine gas (electrochemical reduction to arsine is one step beyond the reduction to arsenic). The inventors now discovered that arsenate can be easily and selectively reduced to arsenite using a non-electrochemical approach to circumvent the difficulties associated with electrochemical reduction.

In one preferred aspect of the inventive subject matter, a mixture of arsenite and arsenate was chemically reacted to selectively convert arsenate to arsenite in the mixture. A variety of reagents are known in the art, including hydrazine, sulfur dioxide, metabisulfite, sulfide, and various redox reagents and metal powders like aluminum and zinc. As sulfur dioxide is an inexpensive reagent and the pH is only moderately affected, SO₂ bubbling (or addition of sulfurous acid) was found to be commercially most attractive. Alternatively, the non-electrolytic reduction may also be performed using recombinant arsenate reductase and/or cells expressing arsenate reductase. Depending on the particular non-electrochemical system, the reduction of arsenate to arsenite may be performed prior to enrichment (e.g., using adsorbents as described above) or in the eluent of the adsorbent, which is currently preferred.

Regardless of the particular reagent used for selective reduction of arsenate to arsenite in the mixture of arsenate to arsenite, it should be appreciated that the selective reduction will not be instant. Therefore, the selective reduction reaction is preferably performed in a reactor that also includes an implement to ensure continuous mixing of the reducing agent with the mixture of arsenate to arsenite. There are numerous mixing devices known in the art, and the specific choice of reducing agent will at least in part determine the choice of mixing device. For example, suitable mixing devices include impellers, gas spargers, propellers, optionally rotating agitators, or a device that moves the reactor. Of course, all of the mixing devices may or may not be removably coupled to the reactor. Furthermore, where desirable, the reactor may include one or more control circuits that regulate, temperature, pressure, pH, and/or addition of reducing agent.

Reduction is typically performed on a predetermined schedule, preferably using a single reductant. A person of ordinary skill in the art will be readily able to calculate the time and concentration needed to convert substantially all (i.e., at least 99.9%) of the arsenate to arsenite. In less preferred aspects, only a portion of arsenate (e.g., about 90-99%, less preferably 80-90, even less preferably less than 80%) in the mixture is converted to arsenite. Therefore, preferred reductions will produce a substantially arsenate depleted aqueous solution, having less than 1% arsenate (as calculated from starting arsenate content), more preferably less than 100 ppm, even more preferably less than 10 ppm, still more preferably less than 100 ppb, and most preferably less than 10 ppb. Therefore, it should be recognized that the remaining arsenite species in the former mixture of arsenate and arsenite will be overwhelmingly arsenite.

Depending on the reducing agent, it should be appreciated that the pH of the aqueous solution with reducing agent may vary considerably. Suitable acidity/alkalinity is preferably adjusted to the respective reaction condition that will yield arsenite in the shortest time at best yields. However, it is generally preferred (but not necessary) that the pH is kept at or near neutral to alkaline pH. Especially where the pH is maintained at (or adjusted to) an alkaline pH, it is contemplated that the reduction reaction that is now substantially arsenate depleted can be directly transferred to an electrolytic cell as described below. Alternatively, the reactor may also include a port through which acid and/or base can be added.

In an especially contemplated aspect of the inventive subject matter, the inventors now discovered that it is possible to strip arsenic from arsenite in alkaline solution using a high surface area material in the cathode. Preferably, the high surface area material is or comprises carbon fiber felt, which may or may not be further activated. As used herein, the term “carbon felt” refers to a textile material that predominantly comprises randomly oriented and intertwined carbon fibers, which are typically fabricated by carbonization of organic felts (see e.g., IUPAC Compendium of Chemical Terminology 2nd Edition (1997)). Most typically, organic textile fibrous felts are subjected to pyrolysis at a temperature of at least 1200° K, more typically 1400° K, and most typically 1600° K in an inert atmosphere, resulting in a carbon content of the residue 90 wt %, more typically 95 wt %, and most typically 99 wt %. Furthermore, contemplated carbon felts will have a surface area of at least about 0.01-100 m²/g, and more typically 0.1-5 m²/g, most typically 0.3-3 m²/g, and where the carbon felt is activated, will have a surface area (BET) of more than 100-500 m²/g, more typically at least about 500-800 m²/g, even more typically at least about 800-1200 m²/g, and most typically at least about 1200-1500 m²/g, or even more.

Depending on the organic textile material and carbonization conditions, the carbon felt may be graphitic, amorphous, have partial diamond structures (added or formed by carbonization), or a mixture thereof. In contrast, reticulated or vitreous (glassy) carbon is formed from carbonized thermosetting organic polymer foams that generally have a non-fibrous, open or closed cellular architecture. While not preferred as high surface area material in conjunction with the teachings presented herein, reticulated or vitreous (glassy) carbon may also be used. Most preferably, the carbon felt is prepared from carbonized organic textile fibrous felts and has a surface area of about 0.1-5 m²/g to about 1200 m²/g and even higher (where the carbon felt is activated). While the exact configuration is of the carbon felt may be variable, it is typically preferred that the carbon felt will have a thickness to allow for a flow path from one side to the other of the felt of between 0.1 cm and 10 cm, and even more preferably between 0.5 cm and 5 cm.

It should be noted that such high surface electrodes, and especially in combination with a re-flow electrolytic cell as described below advantageously allow removal of arsenic ions from solution to very low concentrations while maintaining high current efficiencies for the cathodic reaction. Furthermore, to avoid the production of arsine, alkaline electrolytes are generally preferred. However, pH values of up to 3.0 and slightly more acidic (e.g., 2.7) are also deemed suitable. Remarkably, use of alkaline electrolytes has the additional benefit that electrochemically depleted solutions may be employed to strip arsenic from ion exchange media, ferric hydroxide, zirconium hydroxide, or other arsenic adsorbents. Consequently, it should be appreciated that the solutions after electrolytic reduction of the arsenite to arsenic may be employed as a regenerated eluent in devices as described further below. It should be noted that acid electrolytes, although technically suitable, are not preferred herein.

It should still further be noted that at relatively low arsenite concentrations, hydrogen evolution will present a competing reaction, which generally reduces the current efficiency. Remarkably, such secondary effects were avoided by use of a high surface area cathode, and particularly by using a carbon felt in the cathode that was configured to allow flow of the catholyte through the cathode compartment, and especially flow of at least some of the catholyte (typically at least 50%, more typically at least 70%, even more typically at least 90%, and most typically between 90-100%) through the carbon felt. While not wishing to be bound by any particular theory or hypothesis, the inventors contemplate that turbulent flow of the electrolyte created by pumping the solution through the cathode rather than using a planar surface electrode commonly used afforded at least some of the observed advantages. Still further, re-circulating treated catholyte back to the cathode compartment allowed deposition to very low residual arsenite concentration.

Moreover, the inventors found that unexpected high current densities with high current efficiencies were possible by maintaining electrolytic conditions immediately below a level at which hydrogen evolution started. As the process proceeded, the current was reduced as the concentration of arsenic declined so that only the deposition took place. During these process conditions no arsine was detected in the atmosphere above the electrodes. Using such configurations and methods, the inventors loaded a carbon fiber mat cathode to a point where over 70% of the weight was pure metallic arsenic. As the electrode was removed from the cell wet, the arsenic was stable and on drying remains stable and inert.

One particularly preferred electrochemical cell configuration is disclosed in our U.S. patent application with the Ser. No. 10/821,356, filed Apr. 8, 2004, which is incorporated by reference herein. In such electrolytic devices, a cathode is preferably disposed in a cathode container that contains the catholyte, and the anode is disposed in an anode container that includes an anolyte that is circulated between the container and an anolyte circulation tank, wherein the anode container is at least partially disposed in the cathode container. Further preferred anode containers include a separator (e.g., diaphragm or ion exchange polymer), and it is also contemplated that the cathode container is in fluid communication with a tank that contains the catholyte.

Thus, and viewed from a different perspective, an electrolytic cell will include a first container that contains an catholyte comprising arsenite, wherein a cathode is at least partially disposed within the catholyte, a pump that moves at least part of the catholyte through the cathode at a predetermined flow velocity, and a second container that contains an anolyte, wherein the second container is at least partially disposed in the catholyte and comprises a separator that separates the catholyte from the anolyte, wherein the second container further comprises an anode, and wherein the cathode and the second container are positioned relative to each other such that a flow path between the second container and cathode is formed from which arsenic is deposited onto the cathode. The first container in such electrolytic cells may advantageously include a first opening that receives the catholyte and a second opening that discharges the catholyte after the catholyte has contacted the second container, and it is further preferred that the first container is at least partially disposed in a tank that receives the catholyte from the second opening and that provides the catholyte to the first opening.

In especially contemplated configurations and methods, metallic arsenic is cathodically deposited onto a carbon cathode as gray metal from aqueous solution, which is after treatment substantially completely depleted (i.e., comprises less than 10 ppb arsenic ions) of soluble arsenic compounds. Using contemplated configurations and methods, metallic arsenic can be removed from the carbon cathode via sublimation, while the aqueous electrolyte from which the arsenic is recovered can be recycled as leachate or eluent.

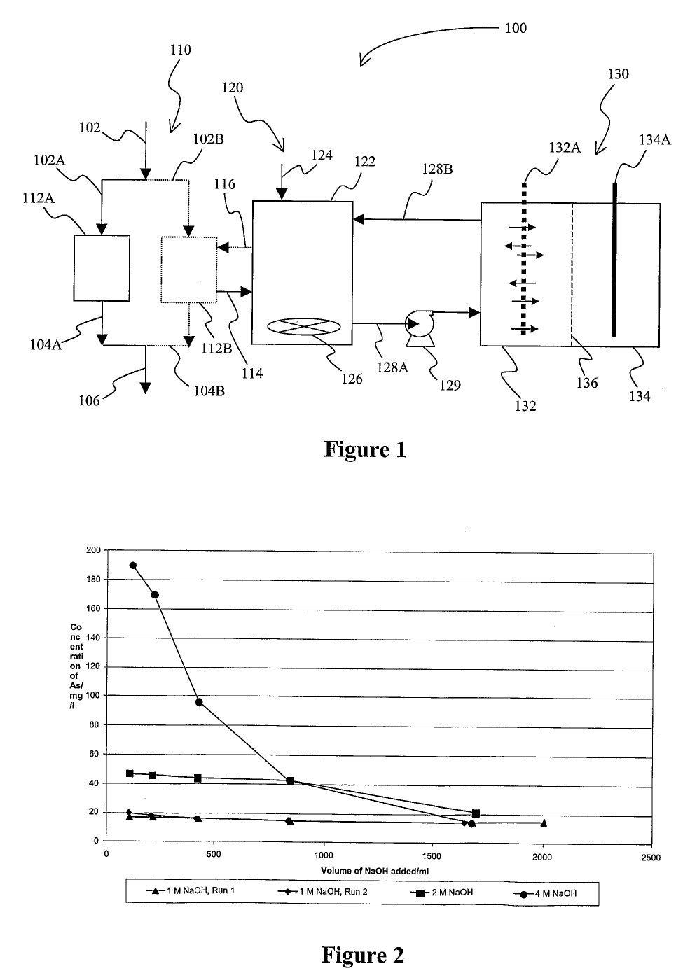

An exemplary system for removal of arsenic species from a water source (e.g., ground water, recycled water, mine leachate, etc.) is depicted in FIG. 1 in which system 100 has an adsorbent subsystem 110 that adsorbs arsenic species from a water supply. A reduction subsystem 120 is fluidly coupled to the adsorbent subsystem 110 and is configured to allow selective reduction of arsenate to arsenite. Electrolytic subsystem 130 is preferably fluidly coupled to the reduction subsystem 120 and is configured to allow reduction of the arsenite to metallic arsenic. Adsorbent subsystem 110 preferably includes a first and a second adsorbing column 112A and 112B that are configured to alternate in receiving the water supply 102 via supply lines 102A and 102B (solid lines in adsorbent subsystem 110 depict flow of water supply). Effluent lines 104 A and 104B carry treated water to delivery pipe 106.

The reactor 122 of the reduction subsystem 120 receives via line 114 eluent from the second adsorbing column 112B while first adsorbing column 112A continues to treat the water supply 102. Reducing agent is added to the arsenic species laden eluent via reducing agent port 124 and mixing system 126 provides for sufficient agitation to ensure a desired degree of reaction between the reducing agent and the eluent. Once reduction is complete, the substantially arsenate depleted solution is pumped via pump 129 and conduit 128A to the electrolytic subsystem 130.

Electrolytic subsystem 130 typically includes a cathode compartment 132, separated by separator 136 from anode compartment 134. The anode compartment 134 includes an anode 134A, while the cathode compartment includes a cathode 132A having a porous high-surface area cathode portion through which at least part of the catholyte is pumped (arrows; flow may be unidirectional or bidirectional as shown). Most preferably, the catholyte is recirculated via conduit 128B to the reactor 122 or other catholyte tank. Once electrolysis is completed, the treated catholyte (now substantially depleted of arsenite to less than 1 ppm, more typically less than 100 ppb, and most typically less than 10 ppb) can then be used as eluent for the first adsorbent column 112A via line 116 (lines to and from first adsorbent column not shown).

Consequently, a method of removing arsenic species from an aqueous solution will include a step of providing an aqueous solution containing arsenate and arsenite, and another step of adding to the aqueous solution a redox agent at a concentration effective to reduce the arsenate in the solution to arsenite, and to thereby form a substantially arsenate depleted aqueous solution. In yet another step, the arsenate depleted aqueous solution is contacted with a cathode comprising a high-surface carbon portion, and in another step, the arsenite is electrochemically reduced in the arsenate depleted aqueous solution at a current effective to deposit metallic arsenic on a cathode to thereby produce a solution that is depleted of arsenic species.

### EXAMPLE

### Adsorption and Desorption of Arsenic from Zirconium Hydroxide Media

Adsorption: Two hundred grams of zirconium hydroxide media was weighed into a beaker and slurried with distilled water; the slurry was about 10% solids. Large clumps of the media were broken up manually using a stirring rod to ensure even consistency. This slurry was poured into a standard, three inch diameter column. The water was removed using a filter pump, leaving the media packed into a bed at the bottom of the column.

An reservoir containing an aqueous solution of 1 mg/l total of As(III) and AS(V) was connected to the top of the column via a peristaltic pump. The outlet (bottom) of the column dripped into a second tank. The pump was started and the solution was pumped through the column, thereby loading the zirconium hydroxide media with arsenic species. Loading of the media continued until the concentration of arsenic species in the outlet solution was equal to that in the inlet solution. Altogether, the media was loaded with arsenic species at about 10 mg arsenic species per g of media.

The column was drained and the media transferred to a beaker, slurried with water for 30 minutes and then left to settle overnight. The supernatant liquid was decanted, and the remaining paste was scraped into a tray and left to dry in air for five hours before being placed in a sealed plastic bottle.

Elution/Regeneration: Thirteen gram samples of the media loaded with arsenic species as described above were slurried with 50 ml of water and packed into a standard one inch diameter column. This gave a media bed approximately 2 cm deep. Two liters of the regenerant, sodium hydroxide, were pumped in a single pass through the media to elute the arsenic species. The eluent was collected in 100 ml fractions, which were analyzed for the arsenic species.

FIG. 2 shows the concentration of arsenic species in the sodium hydroxide regenerant for concentrations of sodium hydroxide from 1 M to 4 M, at a flow rate of approximately 1 bed volume per minute (BV/min). As FIG. 2 shows, less volume of regenerant is required the higher the sodium hydroxide concentration. At 1 M sodium hydroxide, the result is independent of flow rate up to 15 BV/min.

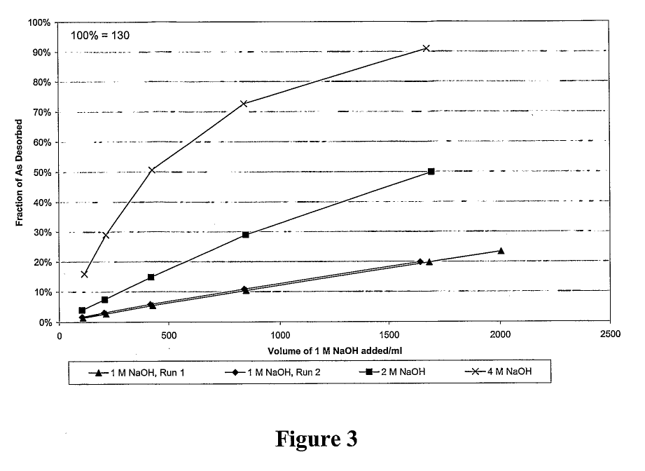

For each of the cases plotted in FIG. 2, the amount of arsenic species desorbed from the media relative to the initial amount of arsenic species loaded onto the media is shown in FIG. 3 (Fraction of arsenic species desorbed from media), which shows that 2 liters of the 4 M NaOH solution removed about 93% of the arsenic species, compared to 23% for 1 M NaOH. These data show that using a more concentrated NaOH solution minimizes the volume of regenerant required, and maximizes the concentration of arsenic species in the regenerant. However, it does not necessarily follow that using a more concentrated NaOH solution minimizes the amount of NaOH required, since using a greater volume at lower concentrations may still equate to less NaOH overall.

### Selective Reduction

A mixed solution of sodium arsenite and sodium arsenate containing the equivalent of 8 grams per liter of arsenic was treated with sulfur dioxide from a gas cylinder sufficient to convert all the arsenate present to arsenite. In this case, about 2 grams of sulfur dioxide was used over a 60 minute period. The solution was stirred in a glass reaction vessel at pH 4 for a further 24 hours (overnight). At this point it was concluded that all arsenate was reduced to the arsenic form. Subsequent experiments with ion chromatography confirmed this conclusion.

### Electrolytic Deposition of Arsenic from Arsenite

An electrochemical cell with a carbon fiber cathode (commercially available from Carbone of America) and a Nafion separator (DuPont) was assembled as described in our copending U.S. patent application with the Ser. No. 10/821,356. The solution was fed by laboratory pump to the cell and the current was adjusted to a current that just failed to liberate hydrogen in the cathode return pipe. The concentration of arsenite was monitored by atomic adsorption analysis of samples of the solution taken at intervals.

During the experiment, the current was adjusted downwards as the arsenic concentration declined. Subsequent analysis of the data indicated current efficiencies in the vicinity of 100% at the start of the reduction (when the concentration was 8 grams per liter of arsenic) and persisted down to 200 ppm where current efficiency had declined to 70%. The reaction was terminated at 100 ppm arsenic species. Several experiments were carried with modified regimes in order to obtain sufficient data to design a full-scale unit. The laboratory cell was operated the flow through carbon felt had so much arsenic plated on and in its surface that flow was restricted. Subsequent analysis showed the carbon felt was composed of 70% gray arsenic. It should be appreciated that the geometrical electrode area can be reduced by 86-90% using felt rather than a flat plate electrode. Pure arsenic can be recovered from the cathode by sublimating the arsenic from the cathode.

Thus, specific embodiments and applications of arsenic recovery have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A method of removing arsenic species from an aqueous solution, comprising:
providing an aqueous solution containing arsenate and arsenite;
adding to the aqueous solution a redox agent at a concentration effective to reduce the arsenate in the solution to arsenite, and to thereby form a substantially arsenate depleted aqueous solution;
contacting the arsenate depleted aqueous solution with a cathode comprising a high-surface carbon portion;
adjusting the pH of the arsenate depleted aqueous solution to an alkaline pH or ascertaining that the arsenate depleted aqueous solution has an alkaline pH; and
electrochemically reducing the arsenite in the alkaline arsenate depleted aqueous solution at a current effective to deposit metallic arsenic on a cathode to thereby produce a solution that is depleted of arsenic species.

2. The method of claim 1 wherein the step of contacting the arsenate depicted aqueous solution comprises a step of pumping the arsenate depleted aqueous solution through the cathode compartment.

3. The method of claim 2 wherein the step of pumping is performed while performing the step of electrochemically reducing the arsenite.

4. The method of claim 2 wherein the step of pumping comprises pumping the arsenate depleted aqueous solution through the high-surface carbon portion.

5. The method of claim 1 wherein the step of electrochemically reducing the arsenite is performed at a current below a current effective to generate hydrogen at the cathode.

6. The method of claim 1 wherein the step of electrochemically reducing the arsenite is performed at an alkaline pH of between 8 and 11.

7. The method of claim 1 further comprising a step of eluting an arsenate and arsenite loaded adsorbent with alkaline eluent to thereby provide the aqueous solution containing arsenate and arsenite.

8. The method of claim 7 further comprising a step of adsorbing arsenate and arsenite from a water supply onto an adsorbent to thereby form the arsenate and arsenite loaded adsorbent.

9. The method of claim 7 wherein the adsorbent comprises at least one compound selected from the group consisting of zirconium hydroxide, titanium hydroxide, and hafnium hydroxide.

10. The method of claim 1 further comprising a step of using the solution that is depleted of arsenic species as an eluent for an arsenate and arsenite loaded adsorbent.

11. The method of claim 1 wherein the step of adding to the aqueous solution the redox agent comprises adding one or more reagents selected from the group consisting of hydrazine, sulfur dioxide, metabisulfite, sulfide, powdered aluminum, and powdered zinc.

12. The method of claim 1 wherein the high-surface carbon portion comprises carbon felt.

13. The method of claim 1 wherein the aqueous solution containing arsenate and arsenite comprises at least 1 g/l of arsenic species.

14. An apparatus comprising:
a first reactor fluidly coupled to an adsorbent system, wherein the first reactor is configured to receive an arsenate and arsenite containing alkaline eluent from the adsorbent system;
a mixing system at least temporarily coupled, to the first reactor and configured to admix a redox reagent with the arsenate and arsenite containing alkaline eluent;
wherein the mixing system is further configured to mix the reagent with the alkaline eluent to a degree effective to allow for substantially complete reduction of arsenate in the alkaline eluent to arsenite;
an electrolytic cell comprising an anode compartment and a cathode compartment, wherein the cathode compartment is fluidly coupled to the first reactor such that the alkaline eluent is circulated from the cathode compartment to the first reactor and from the first reactor to the cathode compartment while electrolysis is in progress; and
wherein the cathode compartment includes a cathode comprising a high-surface carbon portion.

15. The apparatus of claim 14 wherein the first reactor is further configured to provide an eluent to the system.

16. The apparatus of claim 15 wherein the electrolytic cell is configured to allow plating of arsenic onto the cathode from the arsenite to a degree effective to produce the eluent.

17. The apparatus of claim 14 wherein the mixing system comprises at least one of an impeller, a sparger, an optionally rotating agitator, and a blade.

18. The apparatus of claim 14 further comprising a catholyte recirculation pump that is fluidly coupled to the cathode compartment and the first reactor.

19. The apparatus of claim 14 wherein the cathode compartment is configured such that at least part of the catholyte flows through the high-surface carbon portion.

20. The apparatus of claim 14 wherein the high-surface carbon portion comprises a carbon felt.
